(19) United States
(12) Patent Application Publication
(10) Pub. No.: US 2008/0244562 A1
(43) Pub. Date: Oct. 2, 2008

(54) Method of Identifying and Checking Software Installation Requirements

(75) Inventors: Owen Jay Corpening, Austin, TX (US); Jennifer G. Shafer, Austin, TX (US)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/136,387

(22) Filed: Jun. 10, 2008

Related U.S. Application Data
(63) Continuation of application No. 11/201,654, filed on Aug. 11, 2005.

(51) Int. Cl. G06F 9/445

(52) U.S. Cl. 717/174

(57) ABSTRACT

The present invention provides a method, system and computer program product for discovering and checking software installation requirements. In a preferred embodiment, the method begins by parsing and reading the installation requirements already stored in a text file. Once all the requirements have been checked and it is determined that the requirements have been met, the software is then installed.

### BACKGROUND OF THE INVENTION

1. Field of the Invention

The present invention relates generally to data processing systems. Particularly, the present invention relates to a method, system and computer program product for identifying and checking software installation requirements.

2. Description of the Related Art

Many businesses today use computers to perform a variety of tasks. In order to perform these various tasks, application software needs to be installed on the computers.

A major problem is that the installation code for application software has become very complex in regards to checking that proper requirements are met. Each additional requirement requires new code to be added to the installation software. The installation software then has to be rebuilt, repackaged and redistributed. This is especially problematic during development but also require a major effort to fix if a customer requires a modification of the requirements, such as for a new platform, after the product has been shipped. In such a case, new code would need to be added and recompiled and new cd-roms with the updated code would have to be produced and shipped.

Requirements are found through various processes, such as discovery and inventory. Discovery and inventory may mean different things on different types of computers or platforms. Discovery often means determining system parameters. Inventory can any number of things including determining if a certain is in a certain location or determining if a certain line of text is in a certain file. Inventory also includes the situation where a program must be executed and the output of the program must be capture and read. Frequently, inventory means reading a registry with software.

Some examples of common requirements are operating system prerequisites such as type and version, software prerequisites such as required software and version, the existence (or absence) of certain files or registry keys, available disk space, and user privileges. Also included in this category is the discovery of various system information such as the existence and locations of pieces of installed software, the names of users, user privileges, the available disks or partitions, and many other system parameters.

One solution involves writing custom JavaBeans for each new requirement, or to write modular beans which could be modified and reused occasionally. The drawback to this solution is that each requirement change requires rebuilding the cd-rom images with all the associated shortcomings: the code had to be reviewed, versioned, and compiled; and the images had to be re-verified and shipped or copied. The changes themselves are not easy to make, and can sometimes take time with debuggers, trace logs, and reading through all the code just to make the right change. Documenting the software requirements is also difficult in this situation.

Therefore, it would be advantageous to have an improved method, apparatus, and computer program product for identifying and checking that application software requirements are met.

### SUMMARY OF THE INVENTION

The present invention provides a method, apparatus, and computer program product for installing software. In a preferred embodiment, the method begins by parsing and reading the installation requirements already stored in a separate text file. Once all the requirements have been checked and it is determined that the requirements have been met, the software is then installed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented in accordance with a preferred embodiment of the present invention;

FIG. 2 is a block diagram of a data processing system in accordance with a preferred embodiment of the present invention;

FIG. 3 is a block diagram illustrating a data processing system in which the present invention may be implemented;

FIG. 4 is a block diagram illustrating exemplary components for installing software onto a storage device, in accordance with a preferred embodiment of the present invention;

FIG. 5 is a diagram illustrating a document type definition for an XML file, in accordance with a preferred embodiment of the present invention;

FIG. 6 is a diagram illustrating an XML file, in accordance with a preferred embodiment of the present invention;

FIG. 7 is a diagram illustrating a typical stanza, according to a preferred embodiment of the invention;

FIG. 8 is a diagram illustrating possible code fragments that would go in a “wizcondition” at the beginning of the install, in accordance with a preferred embodiment of the invention;

FIG. 9 is a diagram illustrating a prereqActionComposite with install requirements added, in accordance with a preferred embodiment of the present invention; and

FIG. 10 is a flowchart of the process of installing software, in accordance with a preferred embodiment of the present invention.

### DETAILED DESCRIPTION OF THE PREFERRED EMBODIMENT

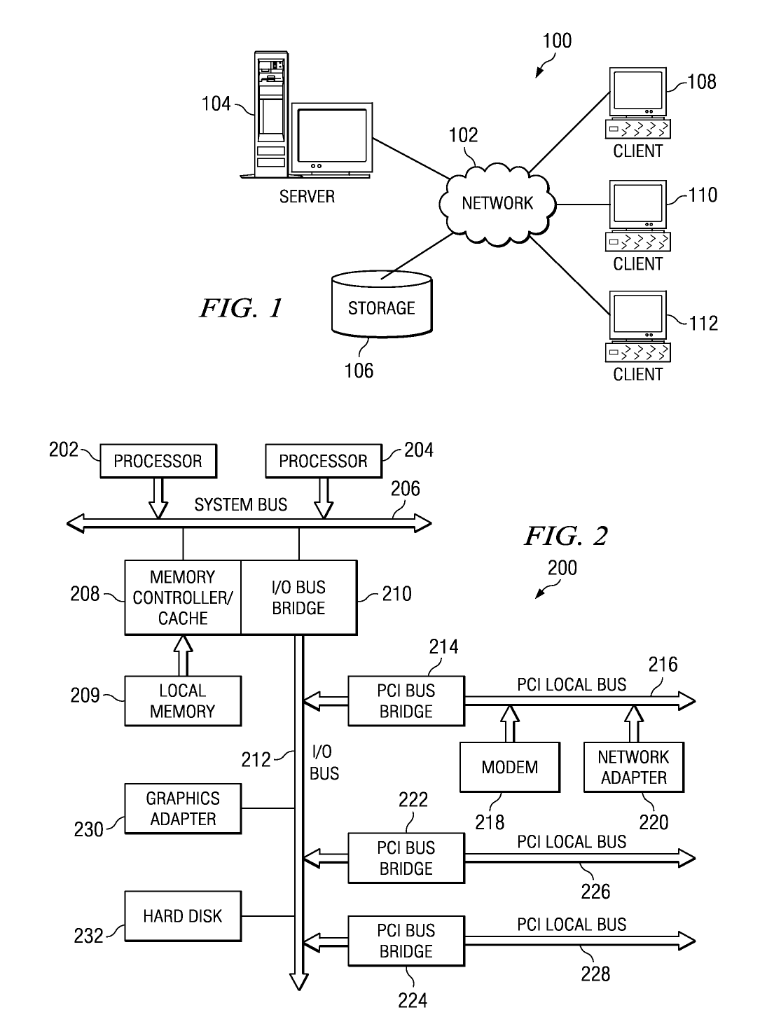

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

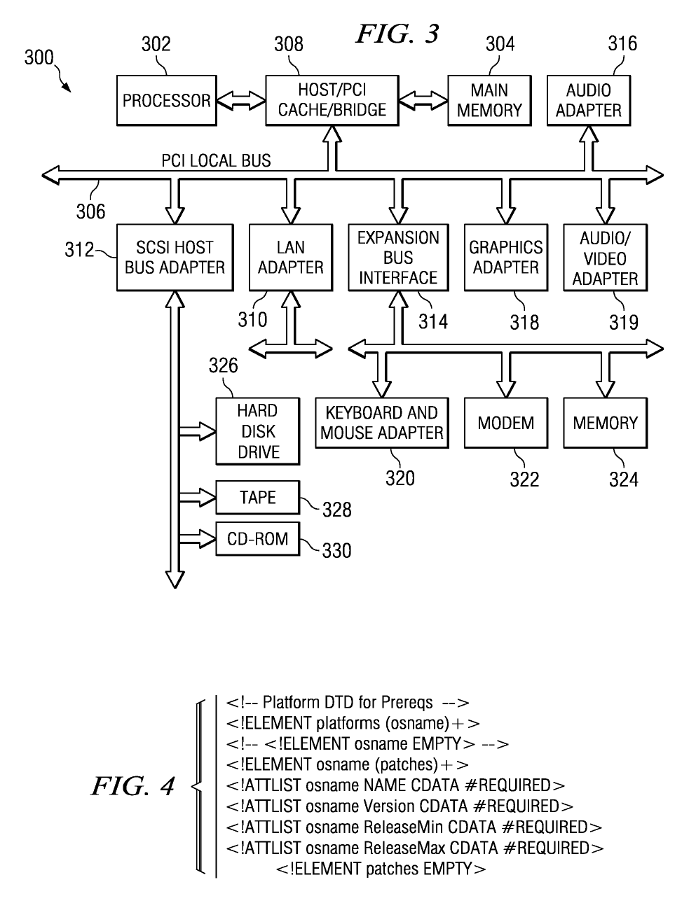

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer program product for installing software. In a preferred embodiment, the method begins by parsing and reading the installation requirements already stored in a separate text file, called an installation requirements information file. Once all the requirements have been checked and it is determined that the requirements have been met, the software is then installed.

Storing the requirements in a separate text file provides an organized, centralized location for all the requirements. A text file is a computer file containing American Standard Code for Information Interchange (ASCII) characters. In a preferred embodiment, the text file is an XML file. However, other markup languages or other formats of text can be used. Additionally, in alternative embodiments, other file formats could be used to store the requirements, including, but not limited to, databases, spreadsheets, rich text files, binary files, etc. These other file types would take the place of the text files used in the preferred embodiment.

The main advantage of storing the requirements separately from the installation software is that the installation requirements information file can be modified without modifying the installation software. The details of these requirements can be changed by the developer or customer with a text editor and don't require recompiling code. Another advantage is that all the requirements can be checked up-front and the results can be used to create a detailed error message if they were not met. The documentation of the requirements is also simplified. The requirements become reusable between projects without introducing or sharing new code. Adding new platforms is particularly simplified, such as the addition of a new Linux variant which is completely compatible with existing variants already supported, but which has a different operating system name and version numbers. Additionally, certification of new operating system versions is dramatically simplified.

In a preferred embodiment, these installation requirements information files are text files, but any type of file or storage could be used. The main idea is that the requirement information is stored separately from the installation software and can therefore be updated without modifying the installation software. Text files are the preferred embodiment because they are the easiest to modify or read.

Referring now to FIG. 4, a block diagram illustrating exemplary components for installing software onto a storage device, in accordance with a preferred embodiment of the present invention is depicted. Software 402 is software to be installed on a data processing system, such as data processing system 300 in FIG. 3. Installer program 404 installs software 402 onto a storage device 410. In order to install software 402 onto storage device 410, installer program 410 loads DTD 406 and XML file 408. DTD 406 serves as a model or description of the format of XML file 408. DTD 406 tells installer program 404 how to read XML file 408. XML file 408 contains the requirements necessary for installing software 402.

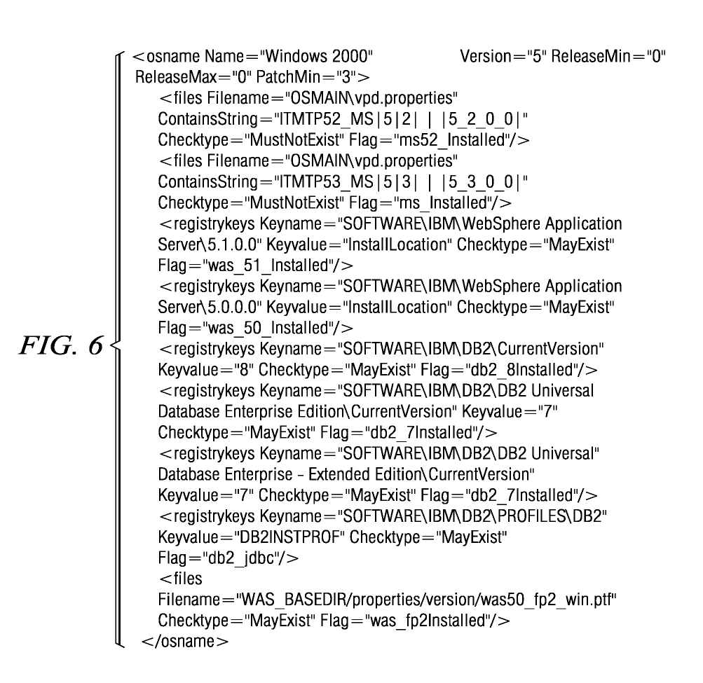

There are many types of requirements that XML file 408 might contain. For example, FIG. 6 shows an XML file containing requirements related to the operating system. However, other types of requirements, including, but not limited to files, registry keys, or java machine versions could be contained in XML file 408. These different requirements could all be stored in one single XML file or they could be stored in a separate XML file, one for each type of requirement. So, in the case where the requirements were stored in multiple XML files, a DTD file would need to be loaded by installer program 404 for each separate XML file.

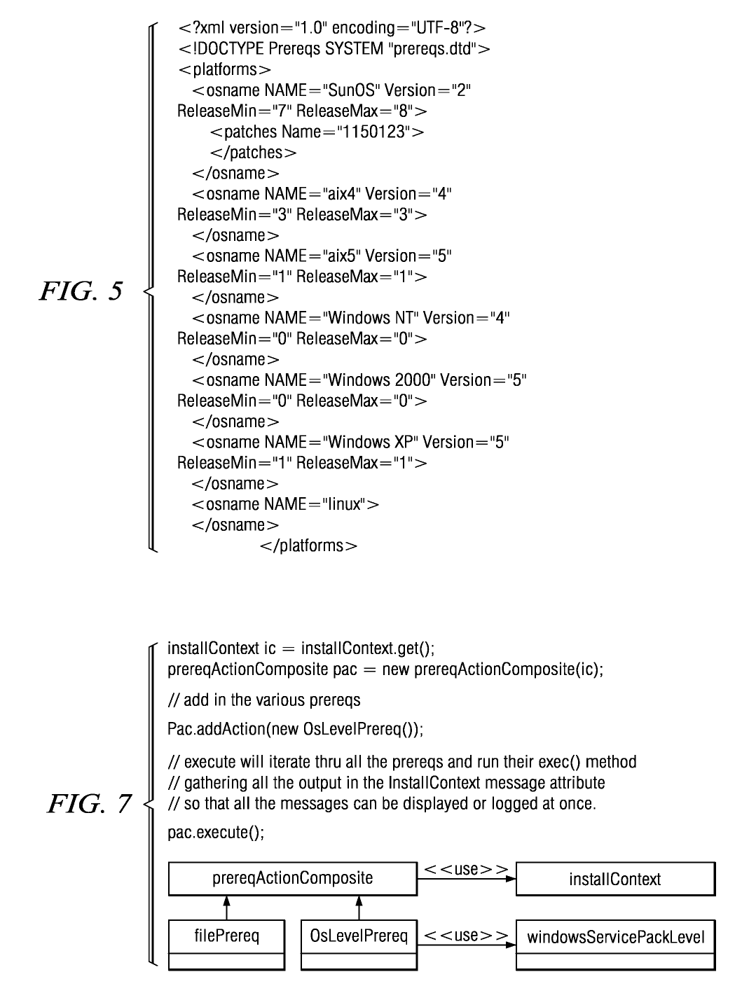

A DTD file describes the format of XML files, including the XML tags and their interrelationships. In a preferred embodiment, the data is organized into sets, called stanzas. Reading DTD 406 tells installer program 404 what fields are contained in XML 408 and how they are organized. DTD 406 contains only one stanza of the information to be stored in XML file 408. The stanza defines the fields in XML file 408 and how they are organized. For example, FIG. 5 depicts a DTD file for an XML file for an operating system. The fields contained in the DTD are the operating system name and version, the minimum and maximum release of the version, and any minimum patch levels required. While DTD 406 contains only one stanza, XML file 408 has many stanzas; but each stanza is organized as defined in DTD 406.

FIG. 5 is a diagram illustrating a document type definition for an XML file, in accordance with a preferred embodiment of the present invention. In a preferred embodiment, the requirements for installing a software application program will be stored externally in XML files, one per installation. All requirements will be checked and a message or panel will be generated indicating success or failure. The message can be anything from a simple message stating success or failure or detailed error message explaining exactly why the software failed to install. FIG. 5 shows a possible DTD for an XML file showing the operating system levels, in accordance with a preferred embodiment of the invention.

Storing the requirements in an XML file provides a great many advantages over the prior art. An XML file provides an organized, centralized location for all requirements. The details of the requirements can be changed by a developer or customer with a text editor and don't require recompiling the code. Another advantage is that all the requirements can be checked up-front and the results can be used to create a detailed error message if they were not met.

Documenting the requirements also becomes simplified. The requirements become reusable between projects without introducing or sharing new code. Adding new platforms is particularly simplified, such as, for example, the addition of a Linux variant that is completely compatible with existing variants already supported, but which has a different operating system name and version numbers. Certification of new operating system versions is also dramatically simplified. Under the present invention all that needs to be updated is the text or XML file, instead of the tedious task of adding and compiling new code, rebuilding the installation software and then repackaging and redistributing it.

FIG. 6 is a diagram illustrating an XML file, in accordance with a preferred embodiment of the present invention. FIG. 6 shows an XML file, as it might appear, containing the requirements for a Management Server, in accordance with a preferred embodiment of the invention. The operating system name identifies each stanza, with the minimum and maximum operating system levels as well as any minimum patch levels required.

FIG. 7 is a diagram illustrating a typical stanza, according to a preferred embodiment of the invention. Inside the stanza for each operating system type, the requirements are listed. These could be files or registry keys that must/must not exist, or text within the files or registry key values that must/must not exist. The stanza also includes flags that are used by the software to retrieve the true/false value of what is discovered, or that hold the values of settings within those files or registry keys.

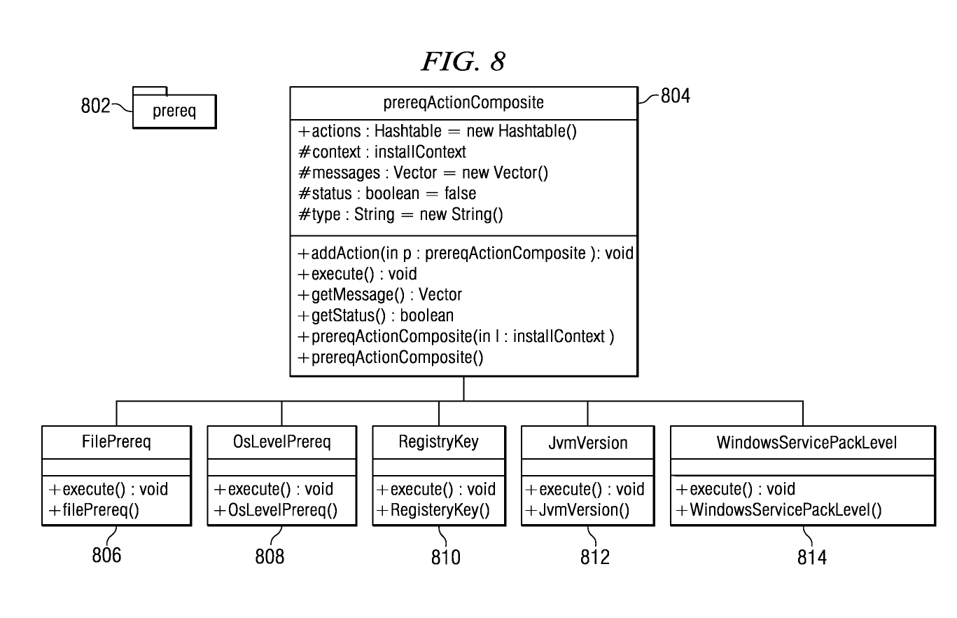

The requirements themselves are stored in an XML file and read at runtime. The requirements are checked in a loop. However, only one iteration of the loop is completed in these examples. The different requirements in an install are added to a list in the prereqActionComposite, which runs them. FIG. 8 is a diagram illustrating possible code fragments that would go in a “wizcondition” at the beginning of the install, in accordance with a preferred embodiment of the invention. A “wizcondition” is a Java™ bean specific to the Install-Shield program. There will be one “wizcondition” per install type which will set the list of prerequisite actions in these illustrative examples.

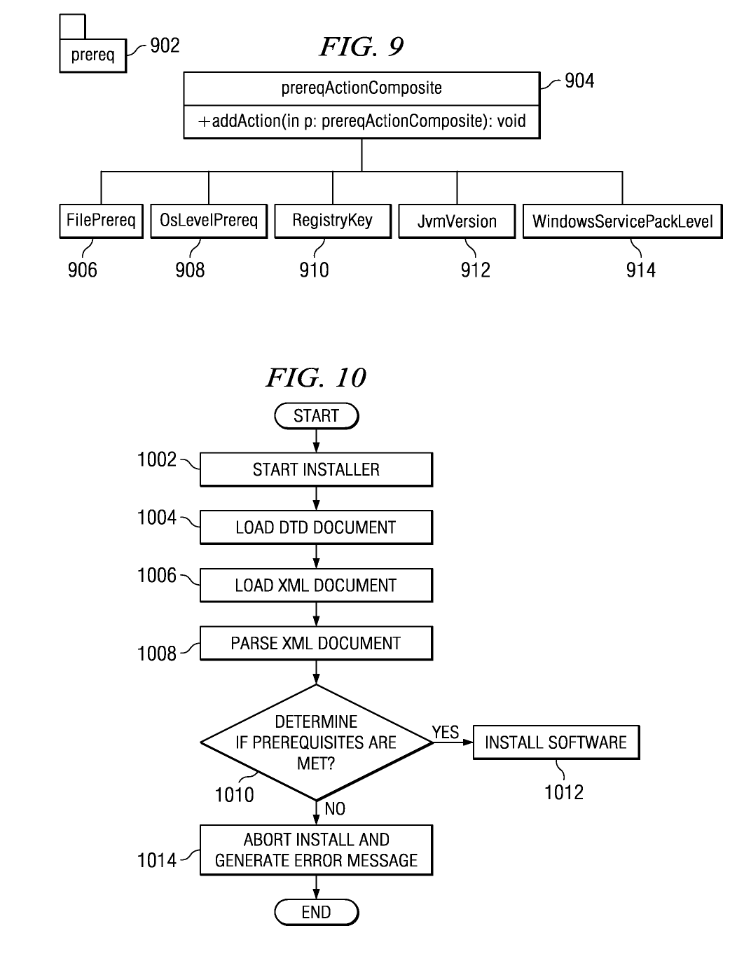

FIG. 9 is a diagram illustrating a prereqActionComposite with install requirements added, in accordance with a preferred embodiment of the present invention. Prereq 902 contains classes that execute certain types of requirement checks, saving all the messages (info, warn, error) in the InstallContext. PrereqActionComposite 904 shows that FilePrereq 906, OsLevelPrereq 908, RegistryKey 910, Jvmversion 912 and WindowsServicePackLevel 914 inherit from PrereqActionComposite. The PrereqActionComposite has a method “addAction” which allows derived items such as the file and OS requirement items to be added to it, forming a list of the requirements.

FIG. 10 is a flowchart of the process of installing software, in accordance with a preferred embodiment of the present invention. In a preferred embodiment, the process starts when a user begins to install software on a data processing system and thus starts an installer, such as installer program 404 in FIG. 4 (step 1002). The installer then loads a DTD file, which serves as model or description of the XML file containing the requirements (step 1004). The installer then loads the XML file (step 1006). In a preferred embodiment, the name of the XML file to be loaded is part of the installation software code. However, the file name could be specified at run time. For example, there could be a command line argument asking for the name of the file to be used or there could be a separate panel, prompting the user for the file name.

The installer parses the XML document (step 1008). Parsing the document allows the installer to read the various requirements for the install process. The installer then runs through a single iteration of a loop of the requirements and determines if the requirements are met by the data processing system (step 1010). If the requirements are met (a yes output to step 1010), the software is installed (step 1012). If the requirements are not met (a no output to step 1010), the install is aborted and an error message is generated (step 1014). In a preferred embodiment, all requirements for software to be installed are checked at the beginning of the install process. Nothing is installed until all requirements for all software being installed are satisfied.

Thus the present invention solves the disadvantages of the prior art by providing a method, apparatus, and computer program product for discovering and checking software installation requirements. In a preferred embodiment, the method begins by parsing and reading the installation requirements already stored in an XML file. Once all the requirements have been checked and it is determined that the requirements have been met, the software is then installed.

It is important to note that while the present invention has been described in the context of a fully functioning data processing system, those of ordinary skill in the art will appreciate that the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for installing software, the method comprising:
responsive to execution of an installation process for installing the software, parsing an installation requirement information file, associated with the software, for installation requirements;
determining whether all requirements for installing the software on the data processing system are met using the installation requirements; and
responsive to all the requirements for installing software being met, completing the installation process.

2. The method of claim 1, further includes:
responsive to an absence of all the requirements for installing the software being met, terminating the installation process.

3. The method of claim 1, wherein the installation requirement information file is one of at least a text file, a database file, a spreadsheet file, a rich text format file, and a binary file.

4. The method of claim 1, wherein the installation requirement information file is a text file.

5. The method of claim 4, wherein the text file is a plurality of text files.

6. The method of claim 4, wherein the text file is organized hierarchically, according to platform.

7. The method of claim 4, wherein the text file is an XML file.

8. The method of claim 1, wherein the step of determining that the requirements for installing the software on the data processing system are met includes checking the installation requirements in a single iteration of a loop.

9. The method of claim 1, further includes:
generating a message indicating success or failure of installation.

10. The method of claim 1 wherein the requirements includes at least one of a file prerequisite, OS level prerequisite, registry key, or a java virtual machine version.

11. The method of claim 1 further includes:
adding the installation requirements to a data structure.

12. A computer program product comprising:
a computer usable medium including computer usable program code for installing software, said computer program product including;
computer usable program code, responsive to execution of an installation process for installing the software, for parsing an installation requirement information file, associated with the software, for installation requirements;
computer usable program code for determining whether the requirements for installing the software on the data processing system are met using the installation requirements; and
computer usable program code, responsive to the requirements for installing software being met, for completing the installation process.

13. The computer program product of claim 12, further includes:
computer usable program code, responsive to an absence of the requirements for installing the software being met, for terminating the installation process.

14. The computer program product of claim 12, wherein the installation requirement information file is one of at least a text file, a database file, a spreadsheet file, a rich text format file, and a binary file.

15. The computer program product of claim 14, wherein the installation requirement information file is a text file.

16. The computer program product of claim 14, wherein the text file is a plurality of text files.

17. The computer program product of claim 14, wherein the text file is an XML file.

18. The computer program product of claim 12 wherein the requirements includes at least one of a file prerequisite, OS level prerequisite, registry key, or a java virtual machine version.

19. A data processing system for installing software, the data processing system comprising:
parsing mechanism, responsive to execution of an installation process for installing the software, for parsing an installation requirement information file, associated with the software, for installation requirements;
determining mechanism for determining whether the requirements for installing the software on the data processing system are met using the installation requirements; and
installing mechanism, responsive to the requirements for installing software being met, for completing the installation process.

20. The data processing system of claim 19, wherein the installation requirement information file is one of at least a text file, a database file, a spreadsheet file, a rich text format file, and a binary file.
